(19) United States
(12) Patent Application Publication
(10) Pub. No.: US 2010/0187877 A1
(43) Pub. Date: Jul. 29, 2010

(54) Back supporting sling for stadium seating

(76) Inventor: Ronald W. Johnson, Jacksonville, FL (US)

Correspondence Address: ROBERT M. DOWNEY, P.A., 6751 N. FEDERAL HWY., SUITE 300, BOCA RATON, FL, 33487, US

(21) Appl. No.: 12/657,713

(22) Filed: Jan. 25, 2010

Related U.S. Application Data
(60) Provisional application No. 61/206,129, filed on Jan. 27, 2009.

(51) Int. Cl. A47C 31/00; G09F 7/00; G09F 19/00; G09F 23/00

(52) U.S. Cl. 297/228.13; 297/229; 40/584

(57) ABSTRACT

A seat cover for stadium style seats of the type having a seat back and a seat base movable between a lowered and a raised position includes an elongate body of durable fabric having a first end and a second end. The first end is removably affixable to the seat back of the stadium style seat, and the second end is removably affixable to the front edge of the seat base of the stadium style seat. The elongate body, when the first end is affixed to the seat back and the second end is affixed to the seat base when the seat base is in its down position, forms a hammock style sling for a person to sit on.

### BACKGROUND OF THE INVENTION

1. Field of the Invention

The present invention relates to back supporting devices for seats in general, and more particularly, to a sling that attaches to a stadium style fold-down seat to provide a hammock style seat that comfortably supports the lower back

2. Discussion of the Related Art

As the popularity of sports and entertainment events drawing large crowds have increased, so has the usage of stadiums. Older stadiums were originally designed and constructed with bench type seating commonly known as bleachers. These seats offered a place to sit, but had no back rest for support and thus becoming quite uncomfortable for events typically lasting hours. As new stadiums were built, improved seating having back support was also incorporated into the new designs.

Typically, the majority of these improved seats are constructed of hard plastic wherein the seat has a stationary seatback having a mild curvature to receive a person's back, stationary arm rests. The seats also have a mildly curved folding seat base to support a person's thighs and buttocks. The seat bases fold to permit ease of cleaning after an event and to provide ease of passage by individual accessing a seat within the row. Although the comfort of the current style of seats is greatly improved over the old bleacher type seating, the hard surfaces are still unable to individually conform to body contour and are thus unable to provide adequate distribution of support for the thighs, buttocks, and back, and especially the lower back.

While additional seat comfort could be realized by the incorporation of resilient cushions in the seat back and especially in the seat base, these cushions typically require the use of resilient foam covered with a woven cloth material. Since the seats are typically exposed to outdoor elements such as rain and snow, cloth covered foam cushions would tend to absorb moisture from the elements as well as spilled beverages and semi-liquid foods rendering the seats difficult if not impossible to clean from event to event. Thus, stadium seating construction has over the years remained as a combination of elements formed of rigid unyielding materials. Many people who attend sporting events and concerts at large stadiums find even the improved seating to be somewhat uncomfortable, especially over the course of several hours and thus detracting from the enjoyment of the attended event.

In view of the shortcomings associated with the design of stadium seats, and particularly fold-down seats, a need remains for a simple and light-weight device that can be easily and temporarily installed on the stadium seats to provide a more comfortable seating surface that adequately supports the lower back of a person while seated in the stadium seat for several hours.

### SUMMARY OF THE INVENTION

The present invention is directed to a seat cover for stadium style seats of the type having a seat back and a seat base movable between a lowered and a raised position that satisfies the need for support to the lower back of the person sitting in the seat. The seat cover includes an elongate body of durable fabric having a first end and a second end. The first end is removably affixable to the seat back of the stadium style seat, and the second end is removably affixable to the front edge of the seat base of the stadium style seat. The elongate body, when the first end is affixed to the seat back and the second end is affixed to the seat base when the seat base is in its down position, forms a hammock style sling for a person to sit on.

Another aspect of the present invention is a sling-like seat cover for attaching to stadium style seats having a seat back and a seat base movable between a lowered and a raised position. The seat cover includes an elongate body of durable fabric having a first end and a second end. The first end includes a channel forming rigid member secured to the body wherein the formed channel receives a bottom edge of the seat back. The second end defines a pocket for receiving a front edge of the seat base. A first body segment is located proximate to the first end and extends the body length such that the first end is affixable to the bottom edge of the seat back and can abut the back surface of and extend over the top edge of the seat back.

Yet another aspect of the present invention is a seat cover for stadium style seats of the type having a seat back and a seat base movable between a lowered and a raised position. The seat cover includes an elongate body of durable fabric having a first end removably affixable to the seat back of the stadium style seat and a second end removably affixable to the front edge of the seat base of the stadium style seat. The body, when the first end is affixed to the seat back and the second end is affixed to the seat base in its down position, forms a hammock style sling. A leg cushion is affixed to the body proximate to the second end and includes a plurality of parallel spaced apart cylindrical resilient members retained in place by a fabric cover layer affixed to the body about its perimeter. The fabric cover layer is further affixed to the body between adjacent ones of the cylindrical resilient members.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a stadium seat including a seat cover embodying the present invention;

FIG. 2 is a plan view of the seat cover in a flat uninstalled configuration;

FIG. 3 is a side elevation view of the seat cover of FIG. 2 in a flat uninstalled configuration;

FIG. 4 is a cross-sectional view of the cushioned seat area of the seat cover shown in FIG. 2 and taken along the line 4-4, FIG. 2;

FIG. 5 is a cross-sectional view of the seatback engaging pocket of the seat cover shown in FIG. 2 and taken along the line 5-5, FIG. 2;

FIG. 6 is a side elevation view of a stadium seat including an installed seat cover embodying the present invention with the seat base partially raised and the near arm removed for clarity;

FIG. 7 is the side elevation view of FIG. 6 with the seat base fully rotated in the down position;

FIG. 8 is a side elevation view of a person seated in a stadium seat including an installed seat cover and illustrating the support provided to the person's lower back.

Like reference numerals refer to like parts throughout the several views of the drawings.

### DETAILED DESCRIPTION OF THE PREFERRED EMBODIMENTS

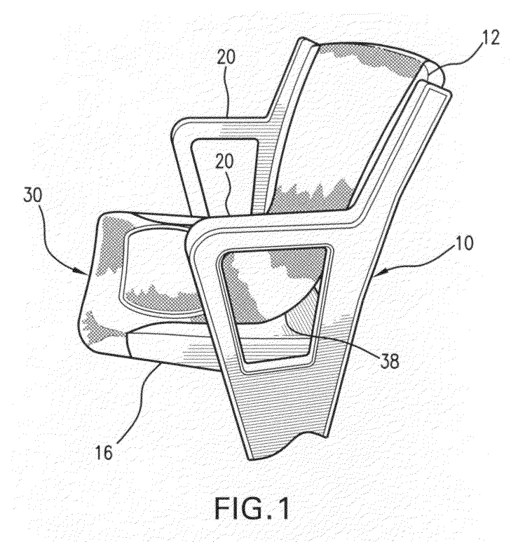

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. While the present invention has been shown and described in accordance with preferred and practical embodiments thereof, one will also recognize that departures from the instant disclosure are fully contemplated within the spirit and scope of the invention. Hence, specific dimensions and other physical characteristics relating to the embodiments disclosed herein are not to be considered as limiting, unless the claims expressly state otherwise.

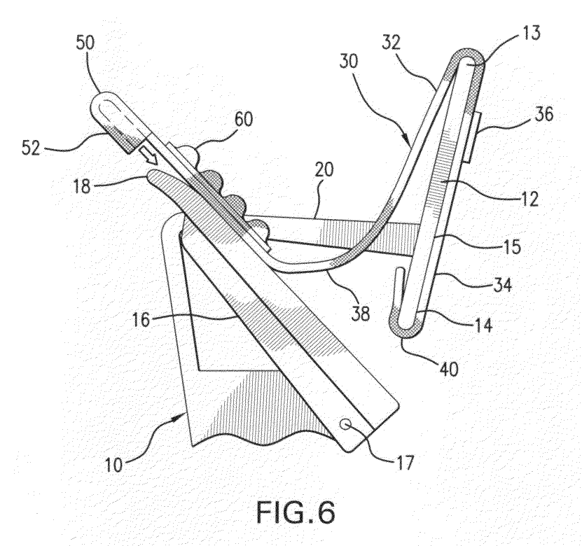

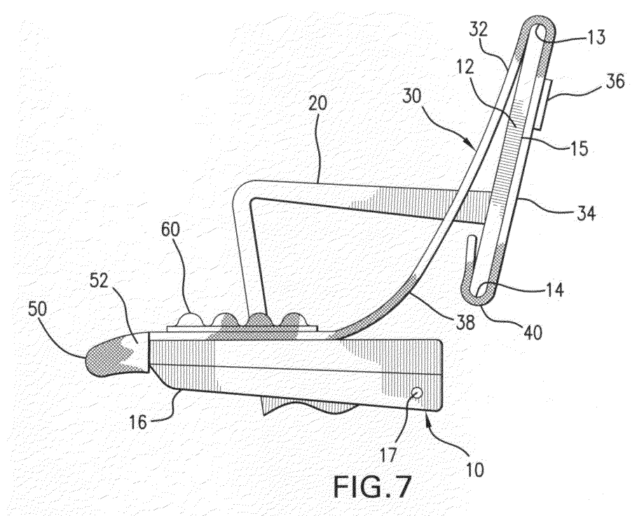

Turning to the drawings, FIG. 1 shows a back supporting sling or seat cover 20 for affixed to a stadium type seat 10 typically found in sports stadiums and arenas which is one of the preferred embodiments of the present invention and illustrates its various components. A stadium type seat 10 typically includes a pair of arm rests 20 which, as shown, also provide primary support for seat 10 on a floor surface such as the tiered seat rows in a stadium. A seat back 12 is suspended in a vertical or near vertical fixed position between arm rests 20. Seat back 20 can also be formed in an arcuate fashion to approximate the side-to-side curvature of a person's back. A seat base 16 is also supported between arm rests 20 and is usually pivotal about a pivot point 17 (FIGS. 6-7) so that the seat can be raised (FIG. 6) for access to interior seats in a particular seat row or for ease of cleaning after the completion of an event. The seat can also be lowered (FIGS. 1 and 7) so that the user of the seat can sit on seat base 16 to watch the event in the stadium or arena. Seat back 12 and seat base 16 are typically formed of a rigid resin such as one of the many polymers commonly known as plastic.

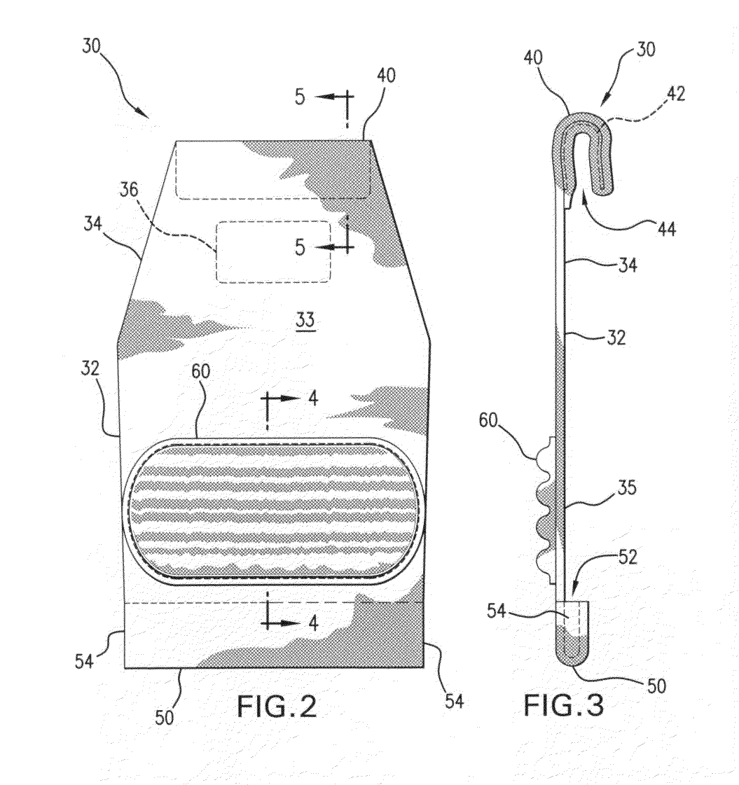

Turning now to FIGS. 2-5, the figures illustrate a back supporting sling or seat cover 20 according to one embodiment of the present invention. Seat cover 20 comprises an elongate body 32 having a first end 40 and a second end 50. Body 32 is typically formed from a durable fabric of synthetic threads or yarns such as neoprene. Alternatively, body 32 can be formed from a homogenous extruded or rolled flexible sheet of a material that does not deform or stretch from long periods of applied tension. Body 32 is of a length that approximates the depth of the seat base plus double the height of the seat back so that the first end of body 32 can be affixed to the bottom edge 14 of seat back 12, extend upward along back surface 15 of seat back 12, over top edge 13 of seat back 12 and then be affixed to front edge 18 of seat base 16 (See FIGS. 6-7).

In the illustrated embodiment, body 32 also includes a first segment 34 which corresponds to the portion of body 32 extending upwards abutting back surface 15 of seat back 12 (FIG. 6). When installed on a stadium seat 10, top surface 33 of segment 34 is visible to the individual seated behind stadium seat 10 and can include an area 36 for product advertising or endorsements such as for brands of beverage, snack items, local businesses or team logos.

First end 40 of seat cover 30 is formed as a rigid channel extending laterally across a central portion of first end 40 of body 32 and defines channel 44. Channel 44 is sized to receive an edge of seat back 12 of stadium seat 10. Channel 44 is further defined by a rigid member 42 formed in the desired channel shape, and, as illustrated in FIGS. 3 and 5 is captured and bonded between layers of the durable fabric of which body 32 is comprised. Alternatively, an edge of rigid member 42 can be securely affixed to an end of body 32 to functionally perform identically to the first end 40 configuration as illustrated in FIG. 5. Rigid member 42 can be formed of metal or of a rigid formable plastic.

Second end 50 of seat cover 30 forms a pocket 52 which receives front edge 18 of seat base 16 in a telescopic manner. Typically, and as shown in FIGS. 2-3, an end of body 32 is folded over toward the bottom surface 35 of body 32 and bonded together at closed pocket ends 54 by a fusion method, a glue, or stitched together with a durable thread, methods presently known in the industry.

Seat cover 20 can also include, as shown in FIGS. 2-4, a leg cushion 60 positioned proximate to second end 50. The purpose of leg cushion 60 is to provide a resilient cushioning of the thigh and lower buttock area of the individual seated on stadium seat 10. Leg cushion 60 includes at least one resilient member 62 on top surface 33 of body 32. Leg cushion 60 extends substantially the lateral width of body 32 and in depth approximately the depth of seat base 16. Resilient member 62 is retained in place and is shielded by durable fabric covering 64. Covering 64 can either be bonded or stitched about its periphery to body 32 to maintain resilient member 62 in its desired position.

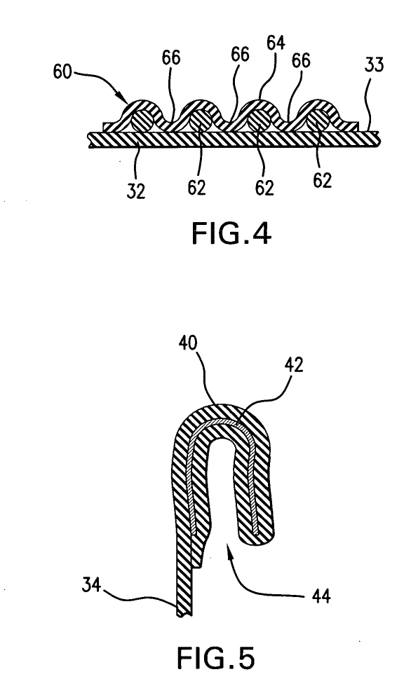

In the embodiment illustrated in FIGS. 3 and 4, cushion 60 is comprised of a plurality of circular rod-like segments 62 of resilient material. Segments 62 are arranged in a parallel spaced apart pattern wherein durable fabric covering 64 is secured to body 32 at each valley 66 between adjacent ones of resilient members 62. Cushion 60 is thus formed in a lateral corduroy-like configuration. The corduroy pattern thus created can alternatively be rotated ninety degrees to run parallel to the length of body 32.

In use, and referring now to FIGS. 6-8, a user 24, upon selecting his assigned or chosen stadium seat, positions first end 40 such that bottom edge 14 of seat back 12 is engagingly received in channel 44 of first end 40. First segment 34 of body 32 is positioned abutting back surface 15 of seat back 12 such that product advertisement 36 is visible to an individual behind seat 10. Body 32 is draped over top edge 13 of seat back 12 toward the front of seat 10. With seat base 16 in at least a partially raised position (FIG. 6), second end 50 is engaged with seat base 16 by telescoping the pocket 54 forming second end 50 over front edge 18 of seat base 16. Once second end 50 has engaged front edge 18 of seat base 16, seat base 16 can be rotated to the full down position (FIG. 7) whereupon body 32 forms a sling area 38 in a hammock-like fashion.

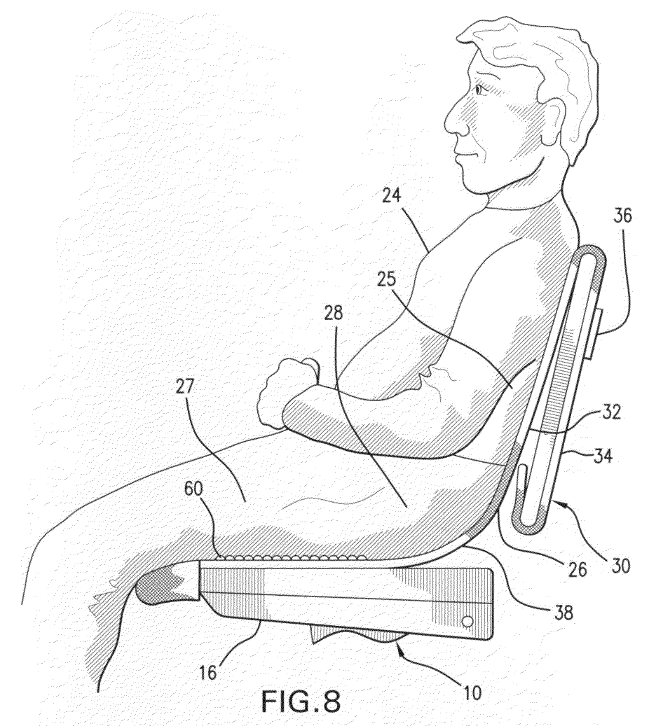

As illustrated in FIG. 8 with user 24 seated in stadium seat 10 and upon seat cover 30, the user's thigh area 27 and lower buttock area 28 are seated upon cushion 60. User 24 also has his upper buttocks 28 and lower back 28 supported by sling area 38 of seat cover 30 and his upper back 25 rests against body 32. Advertisement 36 faces to the rear of seat 10 and is visible to the individual seated behind user 24.

In an alternate embodiment (not shown) body 32 is of shorter length (minus first segment 34) whereby its first end (40) affixes to top edge 13 of seat back 12 in similar manner as first end 40 of seat cover 30 affixes to bottom edge 14 and then extends from top edge 13 to front edge 18 of seat base 16 to form sling 38.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

We/I claim:

1. A seat cover for stadium style seats of the type having a seat back and a seat base movable between a lowered and a raised position, said seat cover comprising:
an elongate body of durable fabric having a first end and a second end;
said first end removably affixable to the seat back of the stadium style seat;
said second end removably affixable to the front edge of the seat base of the stadium style seat; wherein:
said body, when said first end is affixed to the seat back and said second end is affixed to the seat base when the seat base is in its down position, forms a hammock style sling.

2. The seat cover according to claim 1 wherein at least one of said first and said second ends is formed as a channel for securely receiving a portion of the seat back.

3. The seat cover according to claim 2 wherein said channel formed end includes a channel forming rigid member secured to said body.

4. The seat cover according to claim 3 wherein each said first and said second ends includes a channel forming rigid member secured to said body.

5. The seat cover according to claim 2 wherein said second end defines a pocket for securely receiving a front edge of the seat base.

6. The seat cover according to claim 1 further including a leg cushion affixed to said body proximate to said second end.

7. The seat cover according to claim 6 wherein said leg cushion includes at least one resilient member covered with a durable fabric.

8. The seat cover according to claim 7 wherein said leg cushion includes a plurality of substantially parallel cylindrical resilient members arranged in a spaced apart corduroy fashion.

9. The seat cover according to claim 8 wherein said parallel cylindrical resilient members are substantially parallel to said second end.

10. The seat cover according to claim 1 wherein said body includes a first segment proximate to said first end and extending said body length such that said first end is affixable to the bottom edge of the seat back and can abut the back surface of and extend over the top edge of the seat back.

11. The seat cover according to claim 10 wherein said first segment of said body includes a product advertisement visible to a person behind the stadium style seat to which said seat cover is affixed.

12. A sling-like seat cover for attaching to stadium style seats of the type having a seat back and a seat base movable between a lowered and a raised position, said seat cover comprising:
an elongate body of durable fabric having a first end and a second end;
said first end including a channel forming rigid member secured to said body, said formed channel for receiving a bottom edge of the seat back;
said second end defines a pocket for securely receiving a front edge of the seat base; and
a first body segment proximate to said first end and extending said body length such that said first end is affixable to the bottom edge of the seat back and can abut the back surface of and extend over the top edge of the seat back.

13. The seat cover according to claim 12 further including a leg cushion affixed to said body proximate to said second end.

14. The seat cover according to claim 13 wherein said leg cushion includes at least one resilient member covered with a durable fabric.

15. The seat cover according to claim 14 wherein said leg cushion includes a plurality of substantially parallel cylindrical resilient members arranged in a spaced apart corduroy fashion.

16. The seat cover according to claim 15 wherein said parallel cylindrical resilient members are substantially parallel to said second end.

17. The seat cover according to claim 12 wherein said first segment of said body includes a product advertisement visible to a person behind the stadium style seat to which said seat cover is affixed.

18. A seat cover for stadium style seats of the type having a seat back and a seat base movable between a lowered and a raised position, said seat cover comprising:
an elongate body of durable fabric having a first end removably affixable to the seat back of the stadium style seat and a second end removably affixable to the front edge of the seat base of the stadium style seat said body, when said first end is affixed to the seat back and said second end is affixed to the seat base when the seat base is in its down position, forms a hammock style sling;
a leg cushion affixed to said body proximate to said second end, said leg cushion including a plurality of parallel spaced apart cylindrical resilient members retained in place by a fabric cover layer affixed to said body about its perimeter and further affixed between adjacent ones of said cylindrical resilient members.

19. The seat cover according to claim 18 wherein at said first end includes a channel forming rigid member secured to said body forming a channel for securely receiving a portion of the seat back.

20. The seat cover according to claim 19 wherein said second end defines a pocket for securely receiving a front edge of the seat base.
